(19) United States
(12) Patent Application Publication
(10) Pub. No.: US 2004/0176503 A1
(43) Pub. Date: Sep. 9, 2004

(54) Radiation thickened sheet molding compounds

(75) Inventors: Michael A. Czayka, Jefferson, OH (US); Carlos Vargas-Aburto, Chagrin Falls, OH (US); Roberto M. Uribe, Chagrin Falls, OH (US)

Correspondence Address: HAHN LOESER & PARKS, LLP, TWIN OAKS ESTATE, 1225 W. MARKET STREET, AKRON, OH, 44313, US

(73) Assignee: Kent State University

(21) Appl. No.: 10/726,273

(22) Filed: Dec. 2, 2003

Related U.S. Application Data
(60) Provisional application No. 60/430,182, filed on Dec. 2, 2002.

(51) Int. Cl. C08F 2/00

(52) U.S. Cl. 523/500; 525/242

(57) ABSTRACT

The present invention provides a compound and process for manufacturing thickened sheet-molding compounds wherein a thermoset molding resin is partially crosslinked by irradiation with high-energy electrons. In this process, the structure of the resin is changed from a viscous liquid to a viscoelastic gel, which acts like a thickened molding compound.

### TECHNICAL FIELD OF THE INVENTION

The present invention relates to thickened thermoset sheet-molding compounds, and, more particularly, to thickened sheet-molding compounds using electron beam irradiation and to the process of producing these compounds.

### BACKGROUND OF THE INVENTION

Thermoset sheet-molding compounds are used in the compression molding of thermoset products. As is well known, in order to facilitate handling, sheet-molding compounds are thickened through processes that raise the viscosity of the base thermoset resin to a level in the range of 30 to 100 million centipoise. At this moldable viscosity, the sheet-molding compound can be cut into patterns for compression molding.

Traditional thickening of sheet-molding compounds is accomplished through the addition of metal oxide additives to a base resin. The metal oxide combines with the resin to form a polymeric chain that is longer than the base resin. This process forms a neutral salt, and, after all the ingredients are mixed together, the resin paste is mixed with glass reinforcement and allowed to react at room temperature for several days, in which time the viscosity will typically increase to between 30 and 40 million centipoise. The viscosity continues to increase over longer periods of time, but at a much slower rate. This, along with the fact that a catalyst is added to promote curing during processing, limits the shelf life of sheet molding compounds.

Once the material has reached a moldable viscosity, it is ready for compression molding. Compression molding can be considered a three-step process. In step one, a charge is cut from the sheet-molding compound to a specific pattern and mass. In step two, the charge is placed into a steel die consisting of a cavity and core that will form the desired part. The die is then heated to a temperature of 150° C. In step three, the die closes on the charge, and heat is transferred from the die into the charge. The heat causes the viscosity of the charge to drop, and the charge flows to fill the mold.

When the sheet-molding compound has been thickened through the use of a metal oxide additive, the temperature of the die reverses the reaction that formed the neutral salt, and, thus, the viscosity of the metal oxide-thickened sheet molding compound drops. As the latter flows and heats, the catalyst starts the process of crosslinking the polyester resin. First, free radicals are formed due to the addition of heat energy. Often, inhibitors are added to slow down the rate of crosslinking by annihilating free radicals and thereby limiting the number available. Then, as the inhibitor is used up, the free radicals move to break the carbon-carbon double bonds within the polyester chain. Finally, as the crosslinking continues, the viscosity of the charge rapidly rises, and the material is converted to a rigid three-dimensional matrix that forms the molded end product.

While the above technology has been used for many years, it is well known that it is difficult to produce consistent molded products because the properties of the final product tend to vary despite careful attempts to reproduce prior results. The variability is at least partly due to the use of thickening additives, and leads to large quantities of scrap each year. Thus, the present invention focuses on the production of radiation thickened sheet-molding compounds for use in compression moldings, and provides a process that minimizes the variability of the compression molding process to decrease the generation of scrap and thereby yield better economic returns.

Further, the use of thickening additives also creates additional undesirable characteristics relating to the cured molded product ultimately produced. The thickening agents typically used can have an amount of moisture therein, which can cause unwanted chemical reactions during molding. Upon subsequent molding, the mechanical properties of the molded product may be degraded due to such reactions and moisture content. It would therefore be desirable to eliminate use of such thickening agents to minimize such a problem.

In addition, the conventional use of thickening agents may also result in a non-isotropic molded material when fillers and/or reinforcing agents are used. For example, in prior art molding compounds, a reinforcing fiberglass or other material may be used to provide enhanced mechanical properties in the molded product. In past compounds and processes, the use of a thickening agent allows handling of the molding compound, but also allows reversal of the polymerization caused by the thickening agent upon the application of heat. Thus, during a molding process, the viscosity of the material will drop upon the application of heat, allowing the composition to flow such that the reinforcing materials to align in the direction of material flow. This results in orienting such materials and degrading the mechanical properties of the molded article. It would thus be desirable to provide a molding compound and process, wherein a more isotropic molded product is produced.

### SUMMARY OF THE INVENTION

This invention relates to a compound and method to make and use sheet-molding materials, which overcomes the limitations of the prior art. In one aspect, a compound according to the invention comprises an unsaturated oligomer resin, an unsaturated monomer, and a free radical initiator, wherein a selective portion of the molding compound is non-reversibly crosslinked within a predetermined amount, and wherein the viscosity of said compound is increased.

In another aspect, a method of making a thickened compound is accomplished by preparing a composition consisting essentially of an unsaturated oligomer resin, an unsaturated monomer, and a free radical initiator and non-reversibly crosslinking a selective portion of the composition, wherein the viscosity of the composition is increased.

There is also provided, a method of non-reversibly crosslinking a compound, wherein a composition as prepared consisting essentially of an unsaturated oligomer resin, an unsaturated monomer, and a free radical initiator and exposing the composition to high-energy electrons in a preselected area of the composition, wherein a plurality of non-reversible crosslinks are formed. The formation of the crosslinks is dependent upon an absorbed dose and a dose rate of the high-energy electrons.

In another embodiment, there is provided a method of preparing a molding compound, which is suitable for use in compression molding operations. The method comprises preparing a thermoset mixture consisting essentially of an unsaturated oligomer resin, an unsaturated monomer, and a free radical initiator, forming a partially crosslinked mixture by selectively irradiating a portion of the thermoset mixture to a desired increased viscosity, cutting a portion from the partially crosslinked mixture to a desired mass, placing the mass into a mold, and heating the mold to a temperature sufficient to convert the partially crosslinked mixture to a cured and a molded product.

Other aspects and advantages of the invention will become apparent upon a reading of the description of embodiments thereof along with the drawings.

### BRIEF DESCRIPTION OF THE DRAWINGS

FIG. 1 is a plot of absorption data obtained by doing an ATR infrared spectroscopy scan. The plot shows a comparison of the amount of carbon-carbon double bonds within an untreated “Neat Resin”, an “Irradiated Resin”, and a “Cured Resin”.

FIG. 2 displays a plot of exotherms (heat given off) during the curing of samples of an electron beam-thickened molding compound according to an embodiment of the invention.

FIG. 3 is a plot of the maximum compressive load as a function of radiation dose (energy absorbed per unit mass), the latter being measured with FWT-60-00 film dosimeters.

### DESCRIPTION OF THE PREFERRED EMBODIMENTS

In an embodiment of the present invention, a molding compound and process of radiation thickening a thermoset molding compound are set forth, along with other processes according to the invention. The invention works in conjunction with additional basic processing steps employed to make these compounds usable as a fabrication material. In an embodiment, the compound according to the invention may comprise a mixture of unsaturated oligomers, monomers, and organic peroxide. The compound is partially cross-linked upon subsequent molding, the material will be subjected to elevated temperatures, such that as the temperature of the mixture increases, the organic peroxide breaks down into free radicals that react with the unsaturated oligomer by breaking the sigma bond, thereby creating a bridge between the oligomers, via the monomer. These monomer bridges are termed crosslinks. The crosslinking results in a rigid three-dimensional matrix that is insoluble and infusible. In practice, an amount of organic peroxide to allow this reaction to proceed to completion is provided, and cannot be reinitiated. As an alternative to such an embodiment, the present invention also contemplates the ability to forego use of organic peroxide or other free radical initiator, while allowing the material can be completely cured using the techniques of the invention. As will be described hereafter, partial or complete cross-linking can be achieved to make a molding compound or a cured molded product, by means of high-energy electron irradiation. For example, the present invention provides the ability to produce a molded product without the use of a free-radical initiator, such that curing can be performed at only slightly elevated temperatures. The irradiation of the material with high-energy electrons will cause crosslinking by transforming the oligomer into a free radical form for a limited time to allow crosslinking without the use of a free-radical initiator. This in turn may allow the formation of molded compounds with thicker cross-sections, as internal stresses caused by elevated temperatures are minimized, and therefore any warpage caused by such stresses is minimized. Alternatively, partial cross-linking can be achieved to allow handling for a subsequent molding operation, without incurring problems as with prior compounds and processes.

The thermoset resins that are used in the practice of this invention may be unsaturated polyester resins that are formed by condensing an unsaturated polycarboxylic acid or anhydride with at least one polyhydric alcohol. Illustrative of these polyester resins are the products of the reaction of a dicarboxylic acid or anhydride, such as phthalic anhydride, isophthalic acid, tetrahydrophthalic anhydride, hexahydrophthalic anhydride, tetrachlorophthalic anhydride, hexachloroendomethylene tetrahydrophthalic acid, succinic acid, glutaric acid, adipic acid, pimelic acid, suberic acid, azelaic acid, and sebacic acid, and/or an unsaturated dicarboxylic acid or anhydride, such as maleic anhydride, fumaric acid, chloromaleic acid, itaconic acid, citraconic acid, and mesaconic acid, with a dihydric alcohol, such as ethylene glycol, propylene glycol, butylene glycol, diethylene glycol, triethylene glycol, and neopentyl glycol. Small amounts of a polyhydric alcohol, such as glycerol, pentaerythritol, trimethylolpropane, or sorbitol, may be used in combination with the glycol.

Examples of unsaturated polybasic acids or anhydrides which are utilized in the formation of the polyester resins include maleic acid, fumaric acid, itaconic acid, tetrahydrophthalic acid, or the anhydrides of any of the foregoing. Examples of saturated aliphatic polycarboxylic acids include adipic and succinic acids, and examples of aromatic polycarboxylic acids include phthalic acid, isophthalic acid, terephthalic acid and halogenated derivatives such as tetrachlorophthalic acid and anhydride.

Examples of polyols include dihydroxy and trihydroxy compounds which in turn include ethylene glycol, propylene glycol, 1,2-butanediol, 1,3-butanediol, 1,4-butanediol, diethylene glycol, dipropylene glycol, glycerol, neopentyl glycol, and reaction products of alkylene oxides with, for example, 2,2′-bis(4-hydroxy phenylene)propane, (Bis-phenol A).

A three-dimensional structure is produced by reacting the unsaturated polyester through the unsaturated acid component with an unsaturated monomer that is capable of reacting with the polyester resin to form crosslinkages. Suitable unsaturated monomers include styrene, methylstyrene, dimethylstyrene, vinyltoluene, divinylbenzene, dichlorostyrene, methyl acrylate, ethyl acrylate, methyl methacrylate, ethyl methacrylate, diallyl phthalate, vinyl acetate, triallyl cyanurate, acrylonitrile, acrylamide, and mixtures thereof. The relative amounts of the unsaturated polyester resin and the unsaturated monomer in the composition may be varied over a wide range.

In one embodiment, the molding composition includes an amount of a free radical initiator capable of generating free radicals that can initiate crosslinking between the thermoset resins. The polymerization initiators are chosen from materials, which contain a peroxide group. Examples of useful peroxide compounds include t-butyl perbenzoate, t-butyl peroctoate, benzoyl peroxide, t-butyl hydroperoxide, succinic acid peroxide, cumene hydroperoxide and dibenzoyl peroxide.

Wetting agents that can also be used include phosphated polyesters. Examples of commercially available wetting agents are identified as solutions of saturated polyesters with acidic groups. These wetting agents can be employed in the resin compositions at concentrations of up to about 2% by weight, and in one embodiment about 0.5% to about 1% by weight.

Antifoam agents can be used. Typical antifoam agents include the commercially available silicone antifoam agents. Examples of commercially available antifoam agents that can be used include a silicone fluid containing dimethylpolysiloxane.

Other ingredients which may be used include one or more of the following: fillers, fibrous reinforcing materials, pigments, and mold release agents.

Fillers are added as extenders to impart such properties as reduction in shrinkage and tendency to crack during curing. Fillers also tend to improve stiffness and heat resistance in molded articles. Examples of fillers that can be used include alumina trihydrate, calcium carbonate, clays, calcium silicate, silica, talcs, mica, barytes, dolomite, solid or hollow glass spheres of various densities. The particular filler chosen may be dependent upon the cost of such filler, the effect of the filler on mix viscosity and flow properties, or the effect that the filler has on properties such as shrinkage, surface smoothness, chemical resistance, relative weight, flammability and/or the electrical characteristics of the cured molded article.

Fibrous reinforcing materials can be added for the purpose of imparting strength and other desirable physical properties to the cured products formed therefrom. Examples of fibrous reinforcements that can be utilized include glass fibers, asbestos, carbon fibers and polyester fibers, and natural organic fibers such as cotton and sisal. Useful fibrous reinforcements include glass fibers which are available in a variety of forms including, for example, mats of chopped or continuous strands of glass, glass fabrics, chopped glass and chopped glass strands and blends thereof.

In prior art compounds, the use of such reinforcing materials may cause problems in the subsequently molded product. Using thickening agents as described in the background causes lengthening of the polymeric chains, which results in thickening of the material. Subsequently, upon molding at elevated temperatures, the increased lengthening, caused by the thickening agent chemical reactions, is reversed, making the material less viscous and subject to flow, which in turn causes alignment of glass fibers or other reinforcing materials along the direction of flow. This causes degradation of the mechanical properties of the molded product due to reduced material isotropy. In the present invention, the materials partially cross-linked, such that upon later heating during molding, the reinforcing materials are less likely to re-orient, thereby enhancing the isotropic characteristics of the molded article along with physical properties thereof, including increasing the tensile strength and elastic modulus thereof.

Mold release agents also can be included and these are typically zinc, calcium, and magnesium or lithium salts of fatty acids. Specific examples of mold release agents include zinc stearate, calcium stearate, magnesium stearate, lithium stearate, calcium oleate, and zinc palmitate.

Pigments also can be included in the inventive compositions. Typical examples of pigments include carbon blacks, iron oxides, titanium dioxide and phthalocyanines. The pigment can be dispersed into the inventive compositions as dry pigment powders or pre-dispersed forms in non-reactive carriers. Alternatively, as the molding compound according to the invention is produced without the use of thickening agents, it is possible to minimize any coloration of the compound. Further, in production of a molded article, it is possible to avoid use of organic peroxide or other free-radical initiator altogether, using only high-energy electrons to cross-link and cure the compound. This may also allow production of a cured material without coloration imparted by such an initiator or other materials.

In an embodiment, the crosslinking of the thermoset molding compound can be induced by exposure to high-energy electrons. Upon exposure, the electrons collide with other electrons in the oligomer, monomer, and organic peroxide mixture (if present), thereby creating free radicals that initiate the crosslinking reaction. In the present process, by selectively irradiating the material using high-energy electrons, only a limited number of crosslinks are formed, and such cross-linking can be controlled. In the process according to an embodiment of the invention, the energy of the electrons is controlled, to determine the degree of penetration into the material by the electrons. Cross-linking is further controlled by control of the dose, or amount of energy absorbed by the material as well as dose rate, being the time in which the dose is applied to the material. By controlling these parameters, the degree of partial cross-linking can be effectively controlled to cause thickening of the compound, without the use of thickening agents, which chemically react with the materials therein. The partial cross-linking is non-reversible, contrary to the chemical reactions of prior art thickening agents. If an amount of free-radical initiator is used in the compound, such as organic peroxide, the energy of the electronic will cause the initiator to break down and cause partial cross-linking. As the irradiation is for only a short time period to achieve the desired dose and dose rate, further cross-linking by the initiator is controllable also. Further, by causing an increase in viscosity due to partial cross-linking, unused amounts of the broken down initiator, are prevented from migrating and continuing cross-linking reactions. In this way, controllable partial cross-linking is achieved to make a molding compound for use in a subsequent molding operation where cross-linking or curing will be completed. At this time, any organic peroxide or other initiator that is still present in the mixture will, when the material is exposed to heat, react and crosslink to completion. This allows for the mixture to be staged at a point where it can be handled for subsequent molding.

Irradiating the material may be performed in any suitable manner. For example, the high-energy electrons may be generated from an electron accelerator. Electrons are first generated by heating a filament. When such a filament is heated, it emits electrons by a process called thermoionic effect. A voltage gradient causes the electrons to be drawn from the filament and accelerated toward a vacuum tube. The beam of electrons goes from the beam tube and through a scan magnet. The scan magnet moves the beam back and forth across the scan window where the electrons run anywhere from 1 MeV to 5 MeV. With an energy from 1 MeV to 5 MeV, the electron beam is able to go through the metal foil of the scan window and irradiate a material below it. Beam current is also another playing factor in the electron beam. The beam current is the amount of charge being accelerated in a unit of time. Since electrons carry a negative charge, then the beam current is directly related to the number of electrons hitting the irradiating material per unit time. An electron accelerator, bundles electrons into a 3 to 5 cm, in diameter, beam, and uses it to irradiate materials. With this electron beam, reactions take place directly within the molecules of the material much quicker than methods utilizing heat, light, and chemical compounds.

In this embodiment, the viscosity of the sheet-molding compound does not drop markedly during molding, indicating that the crosslinks formed upon exposure to high-energy electrons are permanent and not broken during the molding process. As a result, any reinforcement materials within the molding compound mixture are carried uniformly therein. It is also observed that entrapped air is expelled at the flow front and not at the surface. Additionally, the viscosity of the molding compound is dependent on the number of crosslinks formed, and this number is controlled through the control of electron energy, dose and dose rate. Shelf life is also increased, and monomer emissions decreased, as a result of the monomer being trapped in the three-dimensional gel formed.

### Experimental Section

To experimentally test this invention, comparisons of elastic modulus and maximum tensile strength were made between cured samples thickened with a metal oxide and samples thickened with high energy electrons. Additional comparisons were made between samples at different doses with respect to infrared (IR) absorption, Differential Scanning Calorimetry (DSC), and compressive load.

To evaluate the ultimate tensile strength and modulus, a mix was prepared using a common iso-polyester resin from Reichhold Corporation (Dion® resin 31031). 2560 g of resin were mixed uniformly with 1.25% by weight of a high temperature catalyst, t-butyl perbenzoate (TBPB). The mix was then divided into two equal samples of 1280 g. One sample was sealed in a container, and marked control. The second was dispensed in equal masses into four sheets of poly film contained in forms. Each form was 24.6 cm wide by 24.6 cm in length by 0.64 cm deep. Five layers of chopped strand mat with a mass of 180 g were placed on the resin, a layer at a time. The resin was allowed to soak through the mat. A second sheet of poly film was placed on top of the wet out mat, sealed, and labeled test samples. The control sample was mixed uniformly with 0.75% by weight of magnesium oxide (MgO) for conventional thickening. The control sample was dispensed into the forms, and glass was added in the same manner as for the test samples. The control samples were allowed to thicken for three days at room temperature. Only the test samples were taken to the electron beam facility for irradiation, so that the control samples had no chance of receiving radiation. At the radiation facility, the test samples were exposed to high-energy electrons. The independent variable measured was the radiation dose. All four samples passed through the beam at 4.5 MeV, 6 mA and at a feed rate of 9 m/min. that corresponds to a dose of 4.1 kGy. Absorbed dose was verified through the use of FWT-60-00 dosimeters manufactured by Far West Technology, Inc.

The irradiated samples were molded into plaques (30.5 cm by 30.5 cm by 6 mm). The molding temperature was held at 150±10° C., the molding time was 2 minutes, the molding pressure was 6.9 MPa, and the charge weight was 500 g. The control sample was also molded into plaques in the same manner.

The molding sequence was alternating: control, sample, control, sample, etc. Each plaque was machined into ASTM 638 tensile samples on a computer numerically controlled (CNC) mill. The entire population (50+) of each group was tested for ultimate tensile strength and modulus of elasticity concurrently on a universal testing machine according to the ASTM 638 standard.

### Results

The results of the tensile testing are given in Table 1.

TABLE 1

| Sample | MgO1 | MgO2 | MgO3 | MgO4 | Rad1 | Rad2 | Rad3 | Rad4 |
|---|---|---|---|---|---|---|---|---|
| Ultimate Tensile | 131 | 121 | 126 | 130 | 146 | 148 | 155 | 155 |
| Sigma | 19 | 23 | 16 | 16 | 28 | 20 | 30 | 18 |
| Elastic Modulus | 9660 | 9246 | 9453 | 9660 | 11178 | 10902 | 10695 | 11040 |

| | MgO | RAD | % Difference |
|---|---|---|---|
| Four plaque average: | | | |
| Ultimate Tensile | 127 | 151 | 19 |
| Elastic Modulus | 9522 | 10971 | 15 |

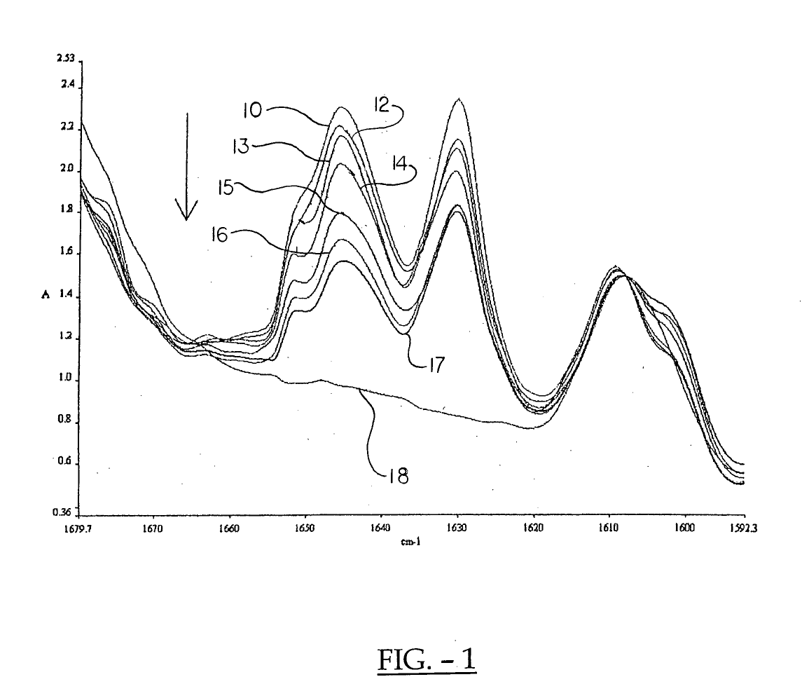

According to this invention, a sample of resin and monomer should contain fewer carbon-carbon double bonds after irradiation than before irradiation, but more than those found in a cured sample of the same resin. FIG. 1 is a plot of absorption data, from an attenuated total internal reflection (ATR) infrared spectroscopy scan. The area of interest in this plot is found at 1646 cm⁻¹ where the bending and stretching frequencies of carbon-carbon double bonds are measured. The curve labeled 10 relates to a “Neat Resin”, corresponding to a mixture of oligomer, monomer, and organic peroxide. It shows a large absorption peak, which corresponds to a large number of double bonds in the uncrosslinked composition. The curves labeled 12-17 relate to “Irradiated Resin”, and represent the absorption peaks from samples exposed to doses of radiation at levels of 5.5 kGy (curve 12), 11.1 kGy (curve 13), 16.6 kGy (curve 14), 22.2 kGy (curve 15), 27.8 kGy (curve 16), and 33.3 kGy (curve 17). As seen in FIG. 1, increasing the level of radiation decreases the overall number of carbon-carbon double bonds in each sample as seen in the absorption data. The curve labeled 18, relates to “Cured Resin”, representing the absorption data for the cured material, and, as expected, reflects a smaller number of double bonds in the sample.

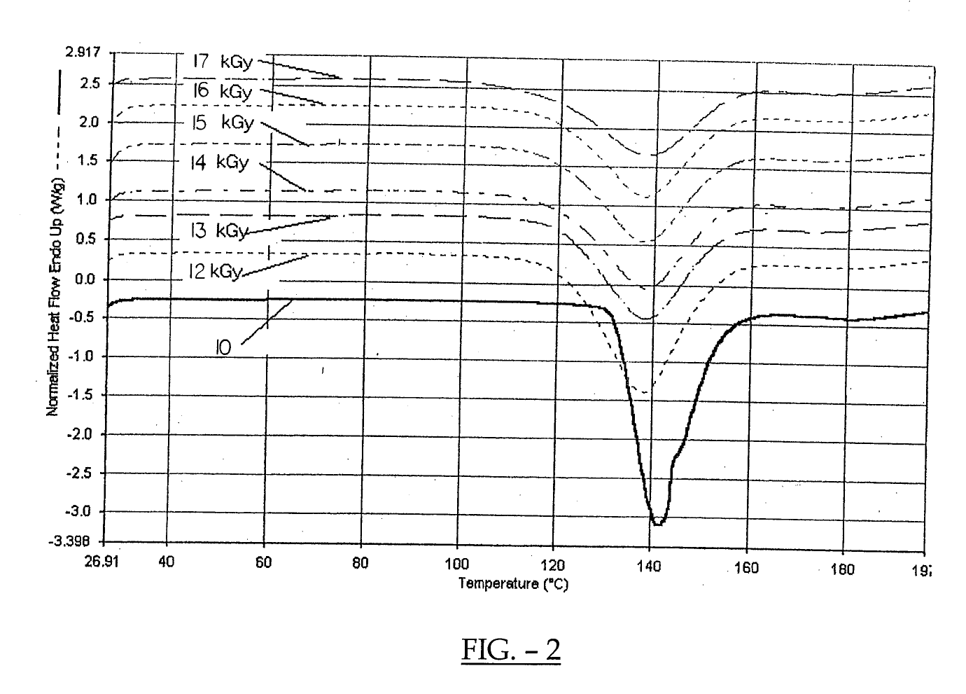

Another method for determining the effects that high-energy electrons have on the molding compound material is to measure the amount of heat given off (exotherm) during the curing process. The curing reaction is exothermic, so the amount of heat liberated is proportional to the number of crosslinks formed. If two samples are prepared in the same manner, where one is exposed to a dose of high-energy electrons and the other is not, and both are then cured, the sample that has been partially crosslinked should show less heat evolved during the curing process. FIG. 2 displays plots of exotherms for samples irradiated at levels corresponding to the samples relating to curves 12-17 of FIG. 1, and similar numerals are used. Thus, different levels of irradiation of the samples, being 5.5 kGy, 11.1 kGy, 16.6 kGy, 22.2 kGy, 27.8 kGy, and 33.3 kGy, are compared non-irradiated neat sample, designated 10. These data were collected using DSC. The total heat per milligram is calculated from these data. It is seen that as the level of irradiation is increased in the various samples, the exotherm measured from the partially crosslinked materials subsequently decreases accordingly. Since less heat was measured in the irradiated samples, this indicates that fewer crosslinks were formed in the irradiated sample. Furthermore, the data shows that the non-irradiated neat sample 10 has the highest exotherm measured providing evidence that this sample has the largest number of crosslinks available during the curing process. Thus, the amount of heat evolved from the partially crosslinked materials, represented by curves 12-17, is less than that of the control sample.

As the number of crosslinks increases, the mechanical properties of the molding compound are expected to also increase. To demonstrate this, two polyethylene molds were built to mold samples. Each mold consisted of five machined cylindrical pockets equally spaced on an 8.5 cm×29 cm×1.4 cm block. Each pocket measured 3.6 cm in diameter by 7 mm deep. This allowed for a constant volume of material to be molded into sample disks.

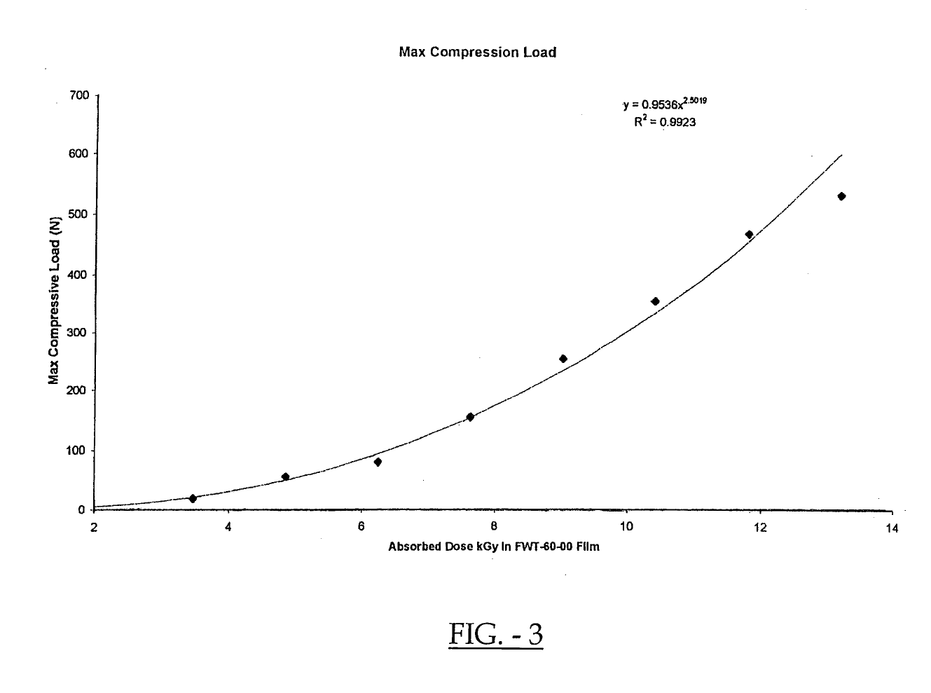

The procedure followed to determine the compressive load, was to add 7 cc of resin containing 1% TBPB catalyst and 40% by weight milled glass fibers to each pocket in both molds. A layer of poly film was used to cover the sample material to keep it from being in contact with air. This is necessary due to the fact that the process is air-inhibited. The molds were then placed on a cart and passed under the beam at doses ranging from 7 to 14 kGy. The sample disks were removed from the mold and wrapped in poly film and labeled with the irradiating conditions. The cylinders were conditioned for two days at room temperature and then removed from the film and stacked two high for compressive testing. Each stack was placed between two flat surfaces in an Instron machine and the stack was compressed a distance of 0.5 cm at a rate of 0.25 cm per min. The maximum load was recorded for each stack. FIG. 3 provides a plot of the compressive load of samples exposed to increasing doses of electrons. Therein, it can be seen that, as the dose increases, the compressive load also increases. This is indicative of crosslinks being formed, resulting in chain entanglement and enhanced mechanical properties.

Thus, it has been shown that exposing thermoset molding compounds to radiation with high-energy electrons allow controllable partial crosslinking of the molding compound. In this way, the molding compound is thickened and, thus, is capable of being handled for processing through compression molding. Due to the fact that the crosslinks formed through the exposure to high-energy electrons are permanent and are not broken during the molding process, the viscosity of the molding compound does not drop markedly during molding, thereby helping to ensure that any reinforcement is carried uniformly in the matrix, enhancing the isotropic nature of the material and its mechanical properties. Additionally, viscosity of the molding compound can be easily controlled by the number of crosslinks formed, which is also easily controlled through the absorbed dose. Shelf life is increased and monomer emissions decreased as a result of the monomer being trapped in a three-dimensional gel.

In view of the foregoing, it should be evident that the present invention, providing radiation thickened sheet molding compounds, substantially improves the art. While, in accordance with the patent statutes, only the preferred embodiments of the present invention have been described in detail hereinabove, the present invention is not to be limited thereto or thereby. Rather, the scope of the invention shall include all modifications and variations that fall within the scope of the attached claims.

What is claimed is:

1. A molding compound comprising:
at least one unsaturated oligomer resin; and
at least one unsaturated monomer; wherein said compound is non-reversibly crosslinked within a predetermined amount, and wherein the viscosity of said compound is increased.

2. A method of making a thickened compound comprising:
preparing a composition consisting essentially of at least one unsaturated oligomer resin, and at least one unsaturated monomer; and
non-reversibly crosslinking said composition a predetermined amount, wherein the viscosity of said composition is increased.

3. A method of non-reversibly crosslinking a compound comprising:
preparing a composition comprising an amount of unsaturated oligomer resin, an amount of unsaturated monomer, and an amount of a free radical initiator; and
irradiating the composition with high-energy electrons, wherein a plurality of non-reversible crosslinks are formed, and wherein formation of said crosslinks is dependent upon an absorbed dose and a dose rate of said high-energy electrons.

4. A method of preparing a compound which is suitable for use in compression molding operations comprising:
preparing a thermoset mixture consisting essentially of an unsaturated oligomer resin, an unsaturated monomer, and a free radical initiator;
forming a partially crosslinked mixture by selectively irradiating a portion of said thermoset mixture to a desired increased viscosity;
cutting a portion from said partially crosslinked mixture to a desired mass;
placing said mass into a mold; and
heating said mold to a temperature sufficient to convert said partially crosslinked mixture to a cured and a molded product.

5. The compound of claim 1 further comprising materials selected from the group consisting of free radical initiators,
polymerization inhibitors, wetting agents, antifoam agents, fillers, fibrous reinforcing materials, pigments, and mold release agents.

6. The compound of claim 1, wherein said unsaturated oligomer resin in an unsaturated polyester resin.

7. The compound of claim 1, wherein said unsaturated monomer is styrene.

8. The compound of claim 1, wherein compound further comprises is an organic peroxide.

9. The compound of claim 1, wherein said compound is non-reversibly crosslinked by selective irradiation from an electron beam of high-energy electrons.

10. The method of claim 2, wherein said composition further comprises materials selected from the group consisting of free radical initiators, polymerization inhibitors, wetting agents, antifoam agents, fillers, fibrous reinforcing materials, pigments, and mold release agents.

11. The method of claim 2, wherein said unsaturated oligomer resin in an unsaturated polyester resin.

12. The method of claim 2, wherein said unsaturated monomer is styrene.

13. The method of claim 2, wherein said free radical initiator is an organic peroxide.

14. The method of claim 2, wherein said composition is non-reversibly crosslinked by selective irradiation from an electron beam of high-energy electrons, with the degree of crosslinking controlled by the electron energy, radiation dose and dose rate.

15. The compound of claim 1, wherein the amount of crosslinking forms a gel material, having a viscosity to allow it to be handled for a subsequent molding process.

16. The compound of claim 1, further comprising at least one reinforcing material, wherein the amount of crosslinking inhibits flow of said reinforcing materials when the compound is subjected to elevated temperatures.

17. A molded article comprising a mixture of at least one unsaturated oligomer resin and at least one unsaturated monomer, wherein crosslinking of the monomer is provided by irradiation of the mixture to cause the at least one oligomer to become a free radical crosslinking the monomer.

18. A process to form a cured article from a polymeric compound,
providing a polymeric compound consisting essentially of at least one unsaturated oligomer resin and at least one unsaturated monomer,
irradiating the compound with high energy electrons having a predetermined energy for an amount of time to cause complete crosslinking in the compound.
